(19) United States
(12) Patent Application Publication
(10) Pub. No.: US 2010/0007579 A1
(43) Pub. Date: Jan. 14, 2010

(54) ELECTRONIC POP APPARATUS, METHOD OF CONTROLLING ELECTRONIC POP APPARATUS AND PROGRAM

(75) Inventor: Masahiro Minowa, Nagano (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Seiko Epson Corporation, Tokyo (JP)

(21) Appl. No.: 12/514,072

(22) PCT Filed: Jul. 11, 2007
(86) PCT No.: PCT/JP2007/001218

§ 371 Date: May 7, 2009

(30) Foreign Application Priority Data
Nov. 13, 2006 (JP) 2006-306259

(51) Int. Cl. G09G 5/00

(52) U.S. Cl. 345/2.3

(57) ABSTRACT

Provided herein is an electronic POP apparatus having: a price tag apparatus mounting unit on which an electronic price tag apparatus is detachably mounted, the electronic price tag apparatus receiving display control data that controls to display a retail price of an item and an additional information to be added to the retail price from an external apparatus and displaying the retail price; an interface unit that communicates with the electronic price tag apparatus; an additional information display unit displaying the additional information; and an additional information display control unit that displays the additional information on the additional information display unit based on the display control data obtained via the interface unit.

### TECHNICAL FIELD

The present invention relates to an electronic POP apparatus for displaying advertising information of commodities, a method of controlling the electronic POP apparatus and a program.

### BACKGROUND ART

There is known a POP display which has an advertisement printed thereon as means for displaying advertising information and is so configured that an electronic price tag apparatus is to be mounted thereon. The POP display is shaped as rectangular thin plate and is formed with an opening at a lower side of the printed advertisement for mounting the electronic price tag apparatus. The electronic price tag apparatus used for a bargain item mounted on the opening can attract attention of customers (refer to Patent Document 1).

### [Patent Document 1] JP-A-2004-361729

### DISCLOSURE OF THE INVENTION

### Problems to be Solved

However, in a case that the advertisement of the electronic price tag apparatus is changed, the POP display needs to be replaced, causing a troublesome operation. To solve such a problem, an electronic POP apparatus having a display for displaying an advertisement (image data) is used in place of the POP display. In this case, the electronic price tag apparatus is mounted on the electronic POP apparatus, and the electronic POP apparatus and the electronic price tag apparatus communicate with a host apparatus respectively, thereby, displays on the respective apparatuses are changed. To communicate with the host apparatus for the electronic POP apparatus, a wireless antenna needs to be provided on the electronic POP apparatus as well as the electronic price tag apparatus, leading to an increase of manufacturing cost and a complicated structure.

In view of the above-mentioned problem, the present invention provides an electronic POP apparatus having a display thereon which is controlled by an external device with a simple structure, a method of controlling the electronic POP apparatus and a program.

### Means to Solve the Problems

An electronic POP apparatus of the invention includes: a price tag apparatus mounting unit on which an electronic price tag apparatus is mounted, the electronic price tag apparatus receiving additional information of an item and/or display control data from an external apparatus; an interface unit that communicates with the electronic price tag apparatus; an additional information display unit that displays the additional information; and an additional information display control unit that controls to display the additional information on the additional information display unit based on the additional information of the item and/or the display control data acquired via the interface unit.

With this structure, as the electronic POP apparatus communicates via the interface unit with the electronic price tag apparatus capable of communicating with the external apparatus, the electronic POP apparatus does not need to communicate directly with the external apparatus. In short, as the electronic POP apparatus communicates with the external apparatus via the electronic price tag apparatus, it is possible to display the additional information on the additional information display unit based on the display control data received by the electronic price tag apparatus from the external apparatus. Thus, as it is no need to provide a wireless antenna on the electronic POP apparatus, it is possible to manufacture an electronic POP apparatus that can communicate with the external apparatus at low cost with a simple structure. It is also possible to reduce setting space as compared with the case where the electronic POP apparatus and the electronic price tag apparatus are set separately, by attaching the electronic price tag apparatus on the price tag mounting unit of the electronic POP apparatus.

In this case, it is preferable that the electronic POP apparatus further includes a display data storing unit that stores image data and/or moving image data, wherein the additional information display control unit controls to display the image data and/or the moving image data stored in the display data storing unit based on the display control data.

In this case, it is preferable that the electronic POP apparatus further includes a display data storing unit that stores a plurality of pieces of image data and/or moving image data, wherein the additional information display control unit selects at least one of the plurality of pieces of image data and/or moving image data stored in the display data storing unit and controls to display on the additional information display unit based on the display control data.

With these structures, as the electronic POP apparatus displays the image data or the moving image data stored therein as displayed additional information based on the display control data received by the electronic price tag apparatus, various POP displays can be achieved without obtaining large volume of image data or moving image data from outside in each case. Therefore, it is possible to reduce facility cost for a line frequency band and is possible to form the item information display system with a simple structure. It is also possible to display various POP displays by storing the plurality of the image data or the moving image data in the electronic POP apparatus.

In this case, it is preferable that the display control data includes a POP code that assigns the image data and/or the moving image data stored in the display data storing unit, and the additional information display control unit selects at least one of the plurality of pieces of image data and/or moving image data stored in the display data storing unit and controls to display on the additional information display unit based on the POP code.

With this structure, as the electronic POP apparatus selects and displays the image data and the moving image data based on the POP code included in the display control data sent from the external apparatus, it is possible to manage the electronic POP apparatus by the external apparatus. It is also possible to control to display the image data and/or the moving image data based on a common POP code, without assigning individual electronic POP apparatus.

In this case, it is preferable that the price tag apparatus mounting unit includes a locking portion that engages with an engaging portion formed on the electronic tag price apparatus to fix the electronic price tag apparatus.

With this structure, as the electronic POP apparatus engages an engaging portion of the electronic price tag apparatus with a locking portion thereof, it is possible to fix the electronic price tag apparatus in a stable state.

In this case, it is preferable that the interface unit is formed by an electrode portion that electrically connects the electronic POP apparatus with the electronic price tag apparatus in the price tag apparatus mounting unit.

With this structure, it is possible to connect the electronic POP apparatus and the electronic price tag apparatus with a single touch, for example, when the electronic price tag apparatus is mounted.

A method of controlling an electronic POP apparatus is such that a price tag apparatus mounting unit on which an electronic price tag apparatus is mounted, the electronic price tag apparatus receiving additional information of an item and/or display control data from an external apparatus, an interface unit that communicates with the electronic price tag apparatus, an additional information display unit that displays the additional information, and an additional information display control unit that controls to display the additional information on the additional information display unit are provided. The method includes acquiring the additional information and/or the display control data from the electronic price tag apparatus by the interface unit, and controlling to display the additional information on the additional information display unit based on the additional information of the item and/or the display control data by the additional information display control unit.

With this controlling method, as the electronic POP apparatus communicates via the interface unit thereof with the electronic price tag apparatus capable of communicating with the external apparatus, the electronic POP apparatus does not need to communicate with the external apparatus directly. In other words, as the electronic POP apparatus communicates with the external apparatus via the electronic price tag apparatus, it is possible to display the additional information on the additional information display unit based on the additional information of the item and/or the display control data received by the electronic price tag apparatus from the external apparatus. Thus, as there is no need to provide a wireless antenna on the electronic POP apparatus, it is possible to communicate with the external apparatus at low cost with a simple structure.

In this case, it is preferable that the electronic POP apparatus further includes a display data storing unit that stores a plurality of image data and/or moving image data, and that the additional information display control unit selects and displays at least one of the plurality of pieces of image data and/or moving image data stored in the display data storing unit based on the display control data in the step of displaying the additional information on the additional information display unit.

With this structure, as the electronic POP apparatus displays the image data or the moving image data stored therein base on the display control data received by the electronic price tag apparatus, it is possible to display various POP displays without acquiring large volume of image data or moving image data from outside. Therefore, it is possible to reduce facility cost for a line frequency band and to have the electronic POP apparatus with simple structure.

A program of the invention causes a computer to execute each of the steps in the method of controlling the electronic POP apparatus described above.

With this structure, it is possible to provided a program that controls the POP display from the external apparatus with a simple structure.

### BRIEF DESCRIPTION OF THE DRAWINGS

FIG. 1 is a control block diagram of an item information display system.

FIG. 2 is a front view of an item display rack.

FIG. 3 is an overall perspective view of an electronic price tag apparatus.

FIGS. 4A and 4B FIG. 4A is a front perspective view of a POP electronic apparatus having the electronic price tag apparatus provided with a connection interface on a rear plate, and FIG. 4B is a perspective view of the POP electronic apparatus without the electronic price tag apparatus seen from a bottom side.

FIG. 5 is a table showing a relationship between a POP code and a display data file.

FIG. 6 is a table showing an item master as an example.

FIG. 7 is a functional block diagram of the item information display system.

FIG. 8 is a flowchart of an item information display process from a host apparatus side.

FIG. 9 is an overall perspective view of the electronic price tag apparatus having the connection interface in a holding groove.

FIGS. 10A and 10B FIG. 10A is a front perspective view of the electronic POP apparatus having the electronic price tag apparatus provided with the connecting interface in the holding groove, and FIG. 10B is a perspective view of the POP apparatus without the electronic price tag apparatus seen from a bottom side.

### REFERENCE NUMERALS

2: electronic price tag apparatus; 3: electronic POP apparatus; 11: retail price; 32: display; 38: connection interface; 44: POP code; 51: price tag mounting unit; 54: holding pawl; 56: locking groove; 103: additional information display control unit; 111: holding groove; 112: holding portion

### BEST MODES FOR CARRYING OUT THE INVENTION

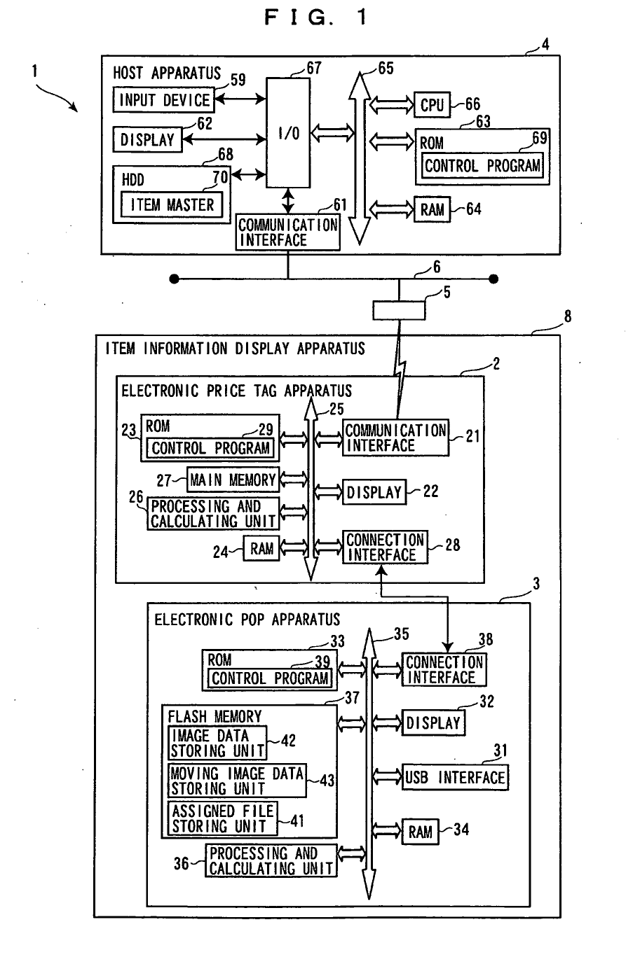

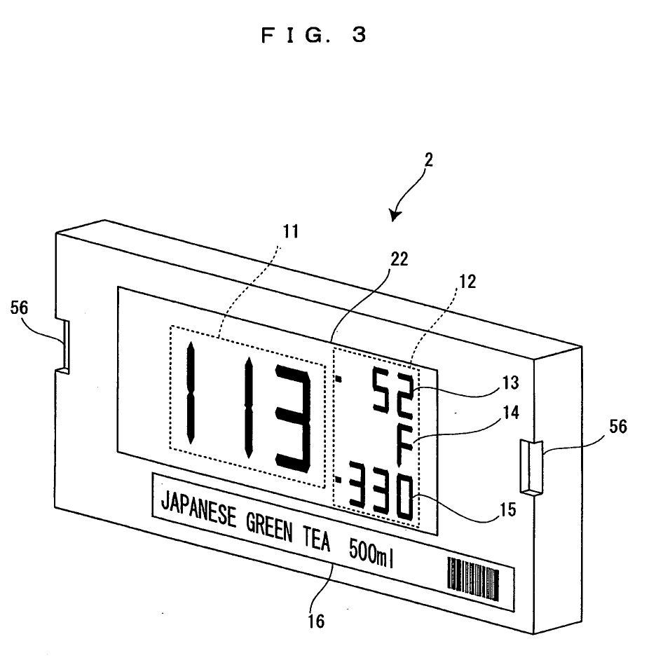

An item information display system using an electronic POP apparatus according to one embodiment of the invention will be explained with reference to accompanying drawings. As shown in FIG. 1, an item information display system 1 includes a plurality of item information display apparatuses 8 (only one of them is shown) for displaying various pieces of information of items, a plurality of antennas 5 (only one of them is shown) set on a ceiling in a store and used for wireless communication with the item information display apparatuses 8, and a host apparatus 4 connected to the plurality of antennas 5 via an in-store LAN 6 and controlling displays of the item information display apparatuses 8. The item information display apparatus 8 includes an electronic price tag apparatus 2 for displaying price information including at least a retail price 11 (see FIG. 3) of an item and an electronic POP apparatus 3 electrically connected to the electronic price tag apparatus 2 and displaying additional information of the item. The host apparatus 4 communicates with each of the electronic price tag apparatuses 2 via the antennas 5 wirelessly. Displays of the electronic price tag apparatus 2 and the POP apparatus 3 are controlled based on display control data sent from the host apparatus 4. Note that the additional information hereinbelow indicates an advertisement for an item or advertising information. Display control data includes the retail price 11 and inventory management information 12 (see FIG. 3) displayed on the electronic price tag apparatus 2, instruction information for displaying the additional information on the electronic POP apparatus 3, and attribute information indicating price attribution of the item. In a case that a displayed item is replaced or the like, item information (an item code 71) is read out from a barcode attached on the item with a handy terminal (not shown) and may be input in the electronic price tag apparatus 2 directly.

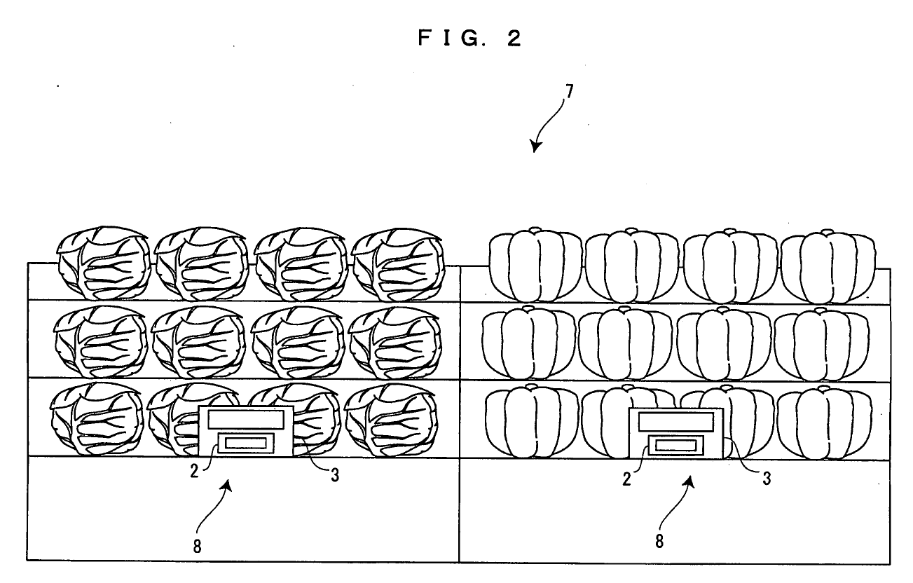

As shown in FIG. 2, an item display rack 7 is formed with setting spaces for the items in a stepwise pattern, of which each stage includes items arranged side by side. The electronic POP apparatus 3 is provided to correspond to the items at a front of the lowest stage. The electronic price tag apparatus 2 is attached on a front face of the electronic price tag apparatus 2. Therefore, customers can easily select items by glancing the price information on the electronic price apparatus 2 and the additional information on the electronic POP apparatus 3.

The electronic price tag apparatus 2 includes a display 22, a communication interface 21, a connection interface 28, a ROM (Read Only Memory) 23, a main memory 27, a computing unit 26 and a RAM (Random Access Memory) 24, and these are interconnected by an internal bus 25. A control program 29 is stored in the ROM 23 and controls process operations in the electronic price tag apparatus 2 (see FIG. 1).

Also, shown in FIG. 3, the electronic price tag apparatus 2 is a rectangular thin plate and a pair of locking grooves (engaging portions) 56 are formed at both ends of a front face so as to be locked by a pair of holding pawls (locking portions) 54 formed on the electronic POP apparatus 3 described later. The display 22 provided at the center of the front face is, what is termed, a liquid crystal display and displays the retail price 11 and the inventory management information 12 based on display control data sent from the host apparatus 4. The inventory management information 12 includes a total amount of sales in this week 13, stock status 14 and a total amount of sales in last week 15, and these are displayed at a front right side thereon in tandem. The stock status 14 is displayed in three ways “F”, “N” and “E”, each meaning lots of stocks, lesser stocks and no stocks, respectively. By considering the inventory management information 12, store staff can predict sales in this week based on the total amount of sales in last week 15 and can decide total number of orders based on the total amount of sales in this week 13 and the stock status 14. At a lower side of the display 22, a label 16 printed with a name of the item and a barcode thereof is attached. The display 22 may be configured of an electronic paper or electronically conductive powder to display an image instead of the liquid crystal display.

The communication interface 21 is used for wireless communication via the antenna 5 set in the store and includes an antenna (not shown). In the embodiment, wireless communication is used, but infra-red communication may be possibly used. The connection interface 28 has a plurality of electrode terminals (electrode portions) (four of them are shown) embedded in a rear face of the electronic price tag apparatus 2 and sends and receives data to/from the electronic POP apparatus 3.

The electronic price tag apparatus 2 may be fed from a button battery such as a lithium battery provided therein, from a solar battery provided on the front face thereof, or from the electronic POP apparatus 3.

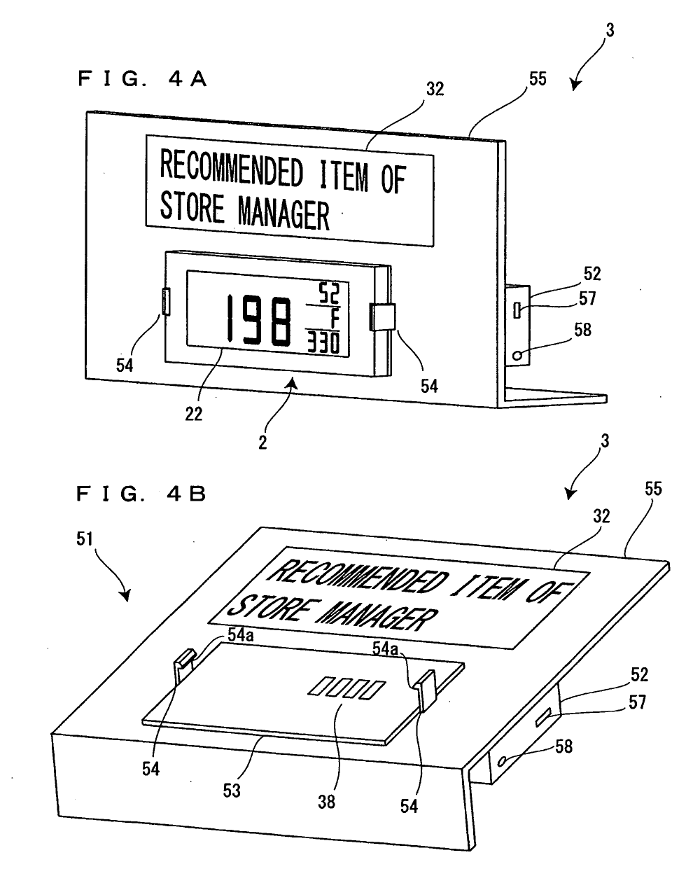

FIG. 4A is a front perspective view of the electronic POP apparatus 3 mounted with the electronic price tag apparatus 2 thereon, and FIG. 4B is a perspective view of the electronic POP apparatus 3 without the electronic price tag apparatus 2 seen from a bottom side. As shown in FIGS. 4A and 4B, the electronic POP apparatus 3 includes a POP body 55 in a bent form so as to have a plate-like frame having L-shaped cross section, a liquid crystal display (an additional information display unit) 32 provided on a front upper side of the POP body 55, a price tag mounting unit (a price tag apparatus mounting unit) 51 to hold the electronic price apparatus 2 provided at a front lower portion of the POP body 55 and a control box 52 attached on a rear face of the POP body 55. A bottom face of the POP body 55 is fixed on the item display rack 7 in a condition that the electronic POP apparatus 3 faces front.

The price tag mounting unit 51 is formed integrally with a rear plate 53 as a set portion for the electronic price tag apparatus 2 and the pair of elastic holding pawls 54 protruding at longitudinal ends of the rear plate 53. The pair of holding pawls 54 are so arranged that respective pawl portions 54a are facing each other and hold so as to surround the electronic price tag apparatus 2 by locking in the pair of locking groove 56 of the electronic price tag apparatus 2. A pawl portion 54a of each of the holding pawls 54 is formed such that a front face thereof is descending for guiding to mount the electronic price tag apparatus 2 and a rear face thereof abutting the locking groove 56 is ascending. Therefore, the electronic price tag apparatus 2 is guided to be mounted smoothly and is immovably held on the rear plate 53 thrustfully by operating component force of elastic force of respective holding pawls 54 against the mounted electronic price tag apparatus 2. The connection interface 38 (an interface unit) having the plurality of electrode terminals (four are shown) is provided in the front face of the rear plate 53 to be embedded therein. In short, the connection interface 38, of which electrode terminals electrically connect the electronic POP apparatus 3 and the electronic price tag apparatus 2, is provided in the price tag mounting unit 51. Corresponding to this structure, in the POP body 55, a through opening (not shown) is formed for passing an electrically conductive lead which is connected to the connection interface 38. The connection interface 38 is connected to the internal bus 35 in the control box 52 by the lead connected through the through opening. When the electronic price tag apparatus 2 is snapped in the price tag mounting unit 51 squarely, the electronic terminals of the electronic POP apparatus 3 and the electrode terminals of the electronic price tag apparatus 2 are electrically connected, and data is sent and received between the electronic POP apparatus 3 and the electronic price tag apparatus 2 through the connection interfaces 28 and 38. It is preferable that at least one of the connection interfaces 28 and 38 is projected from its' attachment face slightly. These connection interfaces 28 and 38 are not necessarily a contact type such as a connector and may be contactless interfaces such as a link by electromagnetic induction, wireless or infra-red.

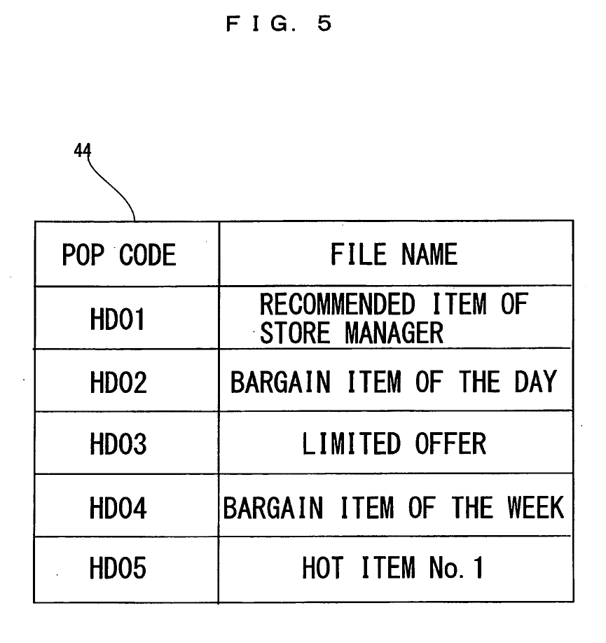

The control box 52 includes a ROM 33, a flash memory 37 such as a FLASH ROM, a RAM 34 and a computing unit 36 inside thereof, and these are interconnected via an internal bus 35. The ROM 33 stores a control program 39 and the electronic POP apparatus 3 controls various processes based on the control program 39 (see FIG. 1). An image data storing unit 42 and a moving image data storing unit 43 in the flash memory 37 store a plurality of image data and moving image data displayed as additional information (hereinafter, image data and moving image data are referred as display data files) corresponding to a POP code 44 respectively (see FIG. 5). An assigned file storing unit 41 in the flash memory 37 stores the POP code 44 of the display data file which is assigned to display. As the POP code 44 is stored in the assigned file storing unit 41 during the display data file is being displayed, when a power failure occurs, a same display is restored after recovery.

As shown in FIG. 5, the display data file is stored to correspond to the POP code 44 in the flash memory 37. By selecting the POP code 44 of the electronic POP apparatus 3 based on the instruction information included in the display control data, a desired display data file is displayed as additional information on the display 32. In short, the instruction information is information that instructs the electronic POP apparatus 3 to select the POP code 44 and to display the display data file. With this structure, the host apparatus 4 can send the instruction information which is a control command containing simple data string (character string and/or numeric sequence) included in the display control data. Therefore, the display data file having relatively large volume does not need to be sent. Therefore, facility cost for a line frequency band can be reduced and the item information display system 1 can be structured simply. In a large-scale retail store having a number of electronic POP apparatuses 3, time needed for sending images can be greatly shortened, thereby loads to the system can be lessened.

At a side of the control box 52, an AC adaptor jack 58 and a USB port 57 are provided. A USB interface 31 connected to the USB port 57 is connected to the internal bus 35, and is used to input the display data file having relatively high volume such as the image data or the moving image data from an external apparatus such as the host apparatus 4.

The host apparatus 4 controls the displays of the electronic price tag apparatus 2 and the electronic POP apparatus 3 by sending the display control data. The host apparatus 4 includes an input device 59, a display 62, a communication interface 61, an input/output interface 67, an internal bus 65, a CPU (Central Processing Unit) 66, a ROM 63, a RAM 64 and a HDD (Hard Disk Drive) 68. An item master 70 is stored in the HDD 68 (see FIG. 1).

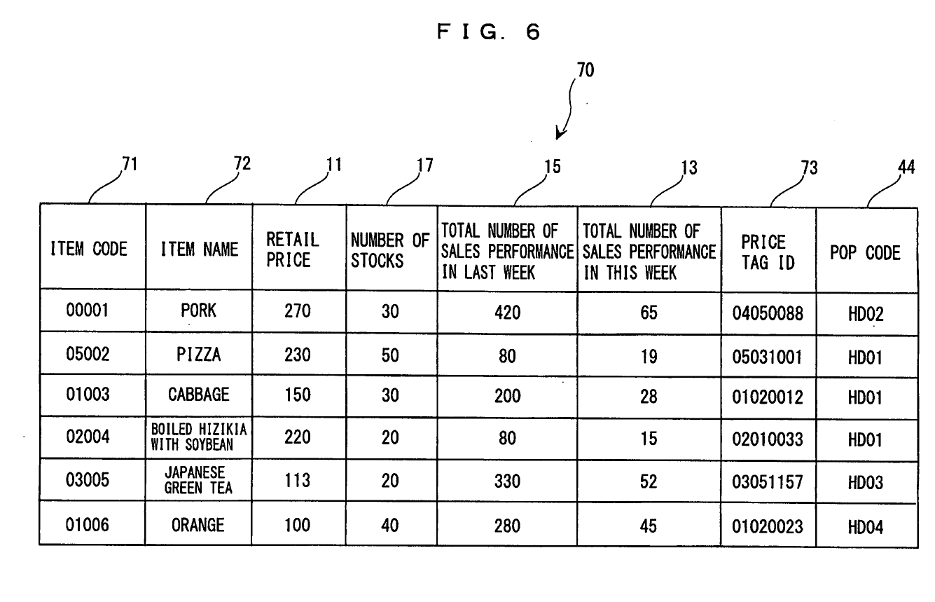

The item master 70 shown in FIG. 6 stores an item code 71, an item name 72, the current retail price 11, the number of stocks 17, the total amount of sales in last week 15, the total amount of sales in this week 13, a price tag ID 73 and the current POP code 44 corresponding to each of the items. The host apparatus 4 generates the display control data including the retail price 11, the inventory management information 12, the instruction information and the attribution information from the item master 70 and sends the display control data to the electronic price tag apparatus 2. When a part of the item master 70 is changed, a display control data having changed content is sent from the host apparatus 4 to the electronic price tag apparatus 2 which is an object to the change, subsequently, the displays of the electronic price tag apparatus 2 and the electronic POP apparatus 3 are changed. As the POP code 44 is described in the item master 70, the host apparatus 4 may assign the price tag ID 73 of the electronic price tag apparatus 2 connected to the electronic POP apparatus 3 to be a changed object based on the POP code 44 rather than assigning individually based on the item code 71, and may send the display control data only to the electronic price tag apparatus 2 corresponding to a common POP code 44. For example, in a case that all of the electronic POP apparatuses 3 displaying “recommended item of store manager” need to be changed, the host apparatus 4 assigns all of the price tag IDs 73 of which POP code 44 in the item master 70 is “HD01”, and sends the display control data to the electronic price apparatus 2 connected to each of the electronic POP apparatuses 3.

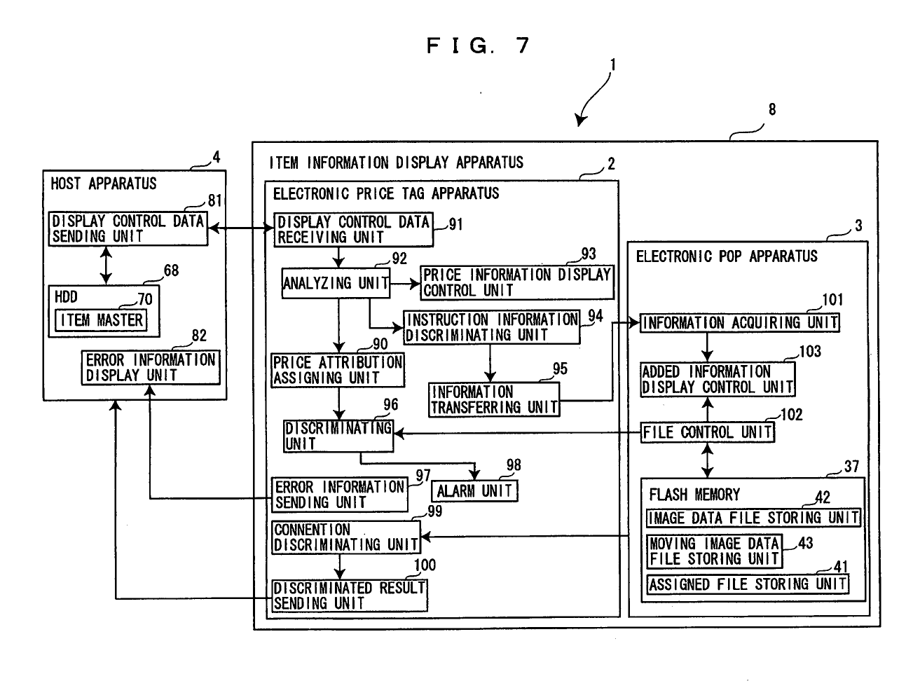

Referring to FIG. 7, a functional structure of the item information display system 1 will be explained.

The electronic price tag apparatus 2 includes a display control data receiving unit 91, an analyzing unit 92, a price information display control unit 93, an instruction information discriminating unit 94, an information transferring unit 95, a price attribution assigning unit 90, a discriminating unit 96, an error information sending unit 97, an alarm unit 98, a connection discriminating unit 99 and a discriminated result sending unit 100.

The display control data receiving unit 91 is used to receive the display control data from the host apparatus 4 via the communication interface 21. The analyzing unit 92 analyzes the received display control data based on the control program 29 stored in the ROM 23. The price information display control unit 93 displays the retail price 11 and the inventory management information 12 on the display 22 when the display control data includes the retail price 11 and the inventory management information 12 based on the result of the display control data analysis. The instruction information discriminating unit 94 discriminates whether the instruction information is included or not based on the result of the display control data analysis. The information transferring unit 95 transfers the instruction information to the electronic POP apparatus 3 via the connection interface 28 when the instruction information discriminating unit 94 discriminates that the instruction information which instructs the electronic POP apparatus 3 to display is included in the display control data.

The price attribution assigning unit 90 assigns attribution information based on the result of the display control data analysis. The discriminating unit 96 acquires a retrieve/select result of the display data file by a file control unit 102 (described later) of the electronic POP apparatus 3 via the connection interface 28, and discriminates presence/absence of the file assigned by the price attribution assigning unit 90. The error information sending unit 97 sends error information to the host apparatus 4 when the electronic price tag apparatus 2 determines that the file assigned by the price attribution assigning unit 90 does not exist based on the discriminated result of the discriminating unit 96 and that correct display can not be performed. For example, the case is such that the analysis result is attribution information showing “HD03” of the POP code 44 and the file corresponding to this code is not stored in the flash memory 37 in the POP. Thus, in the case that the electronic price tag apparatus 2 can not display the display data file properly, that is, in the case that that consistency can not be obtained is discriminated, the error information is sent to the host apparatus 4. Therefore, it is possible for the host apparatus 4 to acknowledge discrepancy between stored information in the electronic POP apparatus 3 and various pieces of information managed by the host apparatus 4 in real-time. With these procedures, the discrepancy between the management information on the host apparatus 4 side and the information of the electronic POP apparatus 3 does not occur, thereby the system can be managed easily.

The alarm unit 98 alarms, when the electronic price tag apparatus 2 discriminates that the discrepancy has occurred based on the discriminated result of the discriminating unit 96, by displaying that the discrepancy has occurred on the display 22. Thus, by alarming with the electronic price tag apparatuses 2 set in a sales floor, sales people are alerted. Therefore, the discrepancy between the additional information of the electronic POP apparatus 3 and various pieces of information managed by the host apparatus 4 can be dealt with in a shop floor level. A sound (electronic sound) may be used to alarm instead of the display 22.

The connection discriminating unit 99 discriminates whether the electronic POP apparatus 3 is connected or not via the connection interface 28. The discriminated result sending unit 100 sends the discriminated result of the connection discriminating unit 99 to the host apparatus 4. With this structure, the host apparatus 4 can discriminate whether the electronic POP apparatus 3 is connected to the electronic price tag apparatus 2 based on the discriminated result by the electronic price tag apparatus 2. Therefore, it is easily possible to manage the electronic POP apparatus 3 connected to the electronic price tag apparatus 2 at the host apparatus 4 side.

The display control data receiving unit 91, the analyzing unit 92, the price information display control unit 93, the instruction information discriminating unit 94, the price attribution assigning unit 90, the error information sending unit 97, the alarm unit 98 and the discriminated result sending unit 100 work as the computing unit 26 computes various data in the main memory 27 based on the control program 29 in the ROM 23 and executes processes in cooperation with the communication interface 21. The information transferring unit 95, the discriminating unit 96 and the connection discriminating unit 99 work as the computing unit 26 computes various data in the main memory 27 based on the control program 29 in the ROM 23 and executes processes in cooperation with the communication interface 21 and the connection interface 28.

The electronic POP apparatus 3 includes an information acquiring unit 101, a file control unit 102 and an additional information display control unit 103.

The information acquiring unit 101 acquires the instruction information included in the display control data from the electronic price tag apparatus 2 via the connection interface 38. The file control unit 102 retrieves and selects the display data file from the flash memory 37 based on the instruction information acquired by the information acquiring unit 101. The additional information display control unit 103 selects the display data file stored in the flash memory 37 via the file control unit 102 based on the acquired instruction information and expands the selected display data file to display data and displays the data as additional information on the display 32.

The information acquiring unit 101, the file control unit 102 and the additional information display control unit 103 work as the processing and computing unit 36 computes various data in the flash memory 37 based on the control program 39 in the ROM 33 and executes processes in cooperation with the connection interface 38.

The host apparatus 4 includes the display control data sending unit 81 and the error information display unit 82. The display control data sending unit 81 sends the display control data to the electronic price tag apparatus 2 via the communication interface 21. The error information display unit 82 displays the price tag ID 73 of the electronic price tag apparatus 2 as an error source in the error information sent from the error information sending unit 97, together with the error information on the display 62. With this structure, as an identification code of the electronic price tag apparatus 2 as the error source is displayed together with the error information on the host apparatus 4, an administrator can specify the electronic price tag apparatus 2 sending the error information and can react promptly.

The display control data sending unit 81 and the error information display unit 82 work as the CPU 66 calculates various data based on the control program 69 in the ROM 63 and various programs in the HDD 68, and executes processes in cooperation with the input device 59 and the communication interface 61.

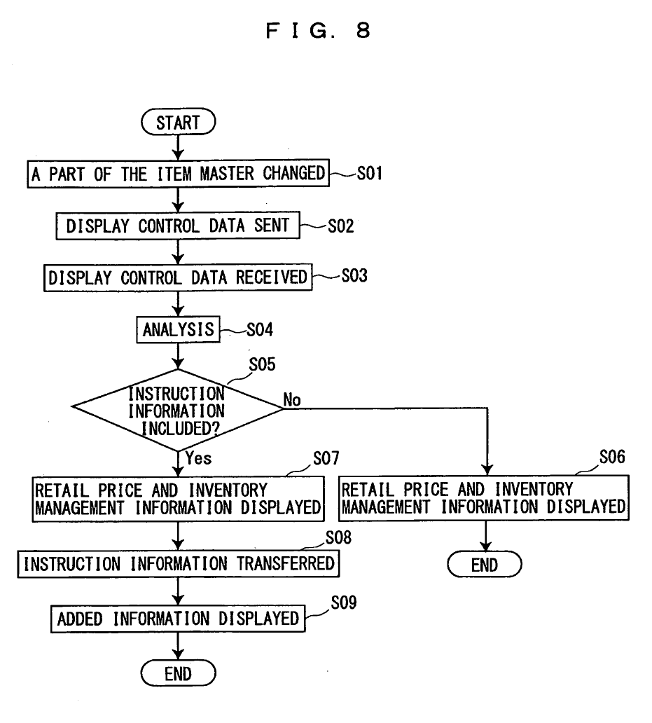

Referring to a flow chart in FIG. 8, an item information display process from the host apparatus 4 side in the item information display system 1 will be explained.

As a part of the item master 70 of the host apparatus 4 is changed (S01), the host apparatus 4 sends the display control data including the instruction information to the electronic price tag apparatus 2 (S02). When the electronic price tag apparatus 2 receives the display control data (S03), the display control data is analyzed (S04). The electronic price tag apparatus 2 discriminates whether the analyzed result includes the instruction information (S05). In a case that the instruction information is not included in the analyzed result (S05: No), the retail price 11 and the inventory management information 12 are displayed on the display 22, and the process ends (S06). On the other hand, in a case that the instruction information is included in the analyzed result (S05: Yes), the retail price 11 and the inventory management information 12 are displayed on the display 22 (S07), and the instruction information is transferred to the electronic POP apparatus 3 (S08). The electronic POP apparatus 3 displays the display data file corresponding to the instruction information on the display 32 after receiving the transferred instruction information (S09).

As described above, according to the embodiment, the electronic POP apparatus 3 does not need to communicate with the host apparatus 4 directly because the electronic POP apparatus 3 communicate with the electronic price tag apparatus 2 capable of communicating with the host apparatus 4 via the connection interface 38. In other words, as the electronic POP apparatus 3 communicates with the host apparatus 4 via the electronic price tag apparatus 2, the additional information can be displayed on the display 32 based on the display control data which was received by the electronic price tag apparatus 2 from the host apparatus 4. Thus, as there is no need to provide a wireless antenna or the like on the electronic POP apparatus 3, it is possible to manufacture the electronic POP apparatus 3 capable of communicating with the host apparatus 4 having a simple structure at low cost. By attaching the electronic price tag apparatus 2 to the price tag mounting unit 51 of the electronic POP apparatus 3, installation space is smaller than that in a case where the electronic POP apparatus 3 and the electronic price tag apparatus 2 are installed separately.

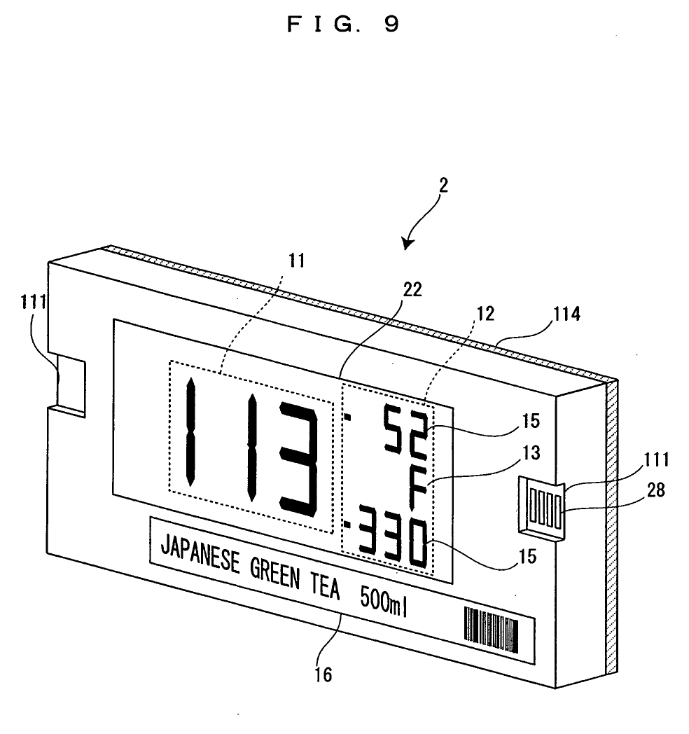

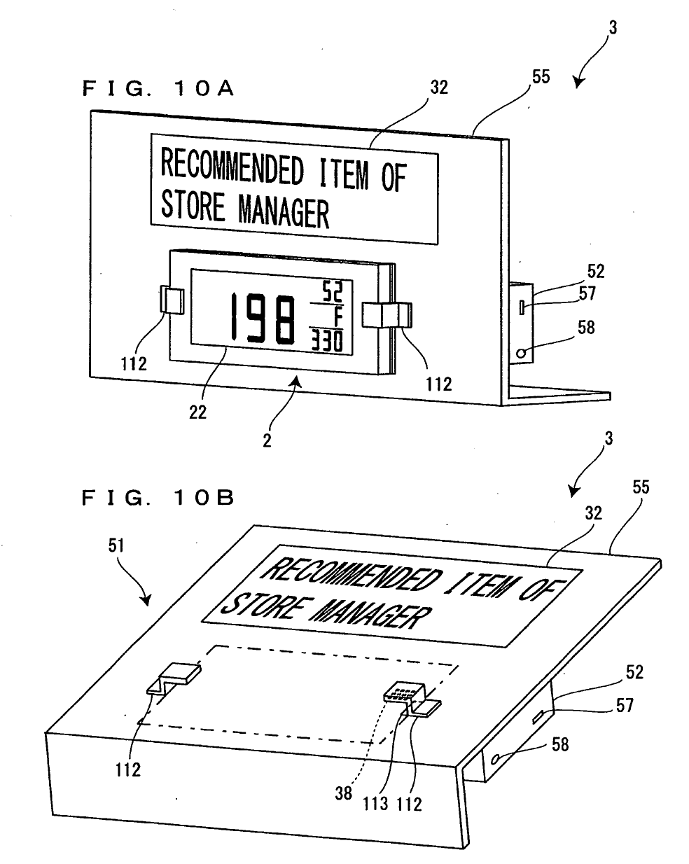

A modification of the above embodiment will be explained with reference to FIGS. 9 and 10. In the modification, the connection interfaces 28 and 38 are arranged in locking portions of the electronic price tag apparatus 2 and the price tag mounting unit 51. More specifically, the connection interface 28 of the electronic price tag apparatus 2 side is arranged in one of a pair of holding grooves 111 formed broadly at both ends on the front face of the electronic price tag apparatus 2. On the other hand, a pair of holding portions 112 in a crank form in cross section are projected corresponding to the pair of holding grooves 111 on the price tag mounting unit 51, and the connection interface 38 of the price tag mounting unit 51 side is provided at one of the holding portions 112. In this case, the lead of the connection interface 38 is embedded in the holding portion 112 and is connected to the internal bus 35 in the control box 52 along the inside of the holding portion 112 via the through opening 113 in the POP body 55 as well as the first embodiment.

At the back face of the electronic price tag apparatus 2, a cushion member 114 (see FIG. 9) made of urethane foam is adhered to instead of the above rear plate 53. When the electronic price tag apparatus 2 is mounted on the price tag mounting unit 51, a user aligns an upper end or a lower end of the electronic price tag apparatus 2 with the pair of holding portions 112, pushes the electronic price tag apparatus 2, and slides it until the holding grooves 111 coincide with the holding portions 112 to mount the electronic price tag apparatus 2 on the price tag mounting unit 51. Thus, the pair of holding grooves 111 are locked by the pair of holding portions 112 and the electronic price tag apparatus 2 is fixed on the electronic POP apparatus 3, thereby intercommunication can be achieved via the connection interfaces 28 and 38. As another structure, each of the holding portions 112 and each of the holding grooves 111 may have the connection interfaces 28 and 38, respectively. With this structure, even if contacting of one of the connection interfaces 28 and 38 is not enough, the other connection interface 28 or 38 can ensure the connection.

It is also possible to provide each part (each function) of the above described item information display system 1 as program. The program can be provided in the form as stored in a storing medium (not shown). As the storing medium, there can be listed a CD-ROM, a flash ROM, a memory card (compact flash, reg. TM, smart media, memory stick, or the like), a magnet-optic disk, a digital versatile disc, flexible disc, or the like.

The present invention will not be limited to the embodiments and examples described above at all. The present invention also includes various modified embodiments without deviating from the scope of the invention in terms of the structure or process of the item information display system 1.

1. An electronic POP apparatus comprising:
a price tag apparatus mounting unit on which an electronic price tag apparatus is mounted, the electronic price tag apparatus receiving additional information of an item and/or display control data from an external apparatus;
an interface unit that communicates with the electronic price tag apparatus;
an additional information display unit that displays the additional information; and
an additional information display control unit that controls to display the additional information on the additional information display unit based on the additional information of the item and/or the display control data acquired via the interface unit.

2. The electronic POP apparatus according to claim 1 further comprising a display data storing unit that stores image data and/or moving image data, wherein the additional information display control unit controls to display the image data and/or the moving image data stored in the display data storing unit based on the display control data.

3. The electronic POP apparatus according to claim 1 further comprising a display data storing unit that stores a plurality of image data and/or moving image data, wherein the additional information display control unit selects at least one of the plurality of pieces of image data and/or moving image data stored in the display data storing unit and controls to display on the additional information display unit based on the display control data.

4. The electronic POP apparatus according to claim 3, wherein the display control data includes a POP code that assigns the image data and/or the moving image data stored in the display data storing unit, and the additional information display control unit selects at least one of the plurality of pieces of image data and/or moving image data stored in the display data storing unit and controls to display on the additional information display unit based on the POP code.

5. The electronic POP apparatus according to claim 1, wherein the price tag apparatus mounting unit includes a locking portion that engages with an engaging portion formed on the electronic tag price apparatus to fix the electronic price tag apparatus.

6. The electronic POP apparatus according to claim 1, wherein the interface unit is formed by an electrode portion that electrically connects the electronic POP apparatus with the electronic price tag apparatus in the price tag apparatus mounting unit.

7. A method of controlling an electronic POP apparatus having a price tag apparatus mounting unit on which an electronic price tag apparatus is mounted, the electronic price tag apparatus receiving additional information of an item and/or display control data from an external apparatus, an interface unit that communicates with the electronic price tag apparatus, an additional information display unit that displays the additional information, and an additional information display control unit that controls to display the additional information on the additional information display unit, comprising:
acquiring the additional information and/or the display control data from the electronic price tag apparatus by the interface unit; and
controlling to display the additional information on the additional information display unit based on the additional information of the item and/or the display control data by the additional information display control unit.

8. The method of controlling the electronic POP apparatus according to claim 7, the electronic POP apparatus further comprising a display data storing unit that stores a plurality of image data and/or moving image data, wherein the additional information display control unit selects and displays at least one of the plurality of pieces of image data and/or moving image data stored in the display data storing unit based on the display control data in the step of displaying the additional information on the additional information display unit.

9. A program causing a computer to execute each of the steps in the method of controlling the electronic POP apparatus according to claim 7.
